(19) United States
(12) Patent Application Publication
(10) Pub. No.: US 2012/0093567 A1
(43) Pub. Date: Apr. 19, 2012

(54) DIAPER RASH CREAM APPLICATOR

(76) Inventor: Alina Kravchenko, San Francisco, CA (US)

(21) Appl. No.: 12/903,738

(22) Filed: Oct. 13, 2010

(51) Int. Cl. B43K 5/02

(52) U.S. Cl. 401/143

(57) ABSTRACT

An applicator apparatus can be attached and detached to and from any tube container that properly fits. The tube is not part of the invention, but works with the invention as a handle and as a dispenser. When the tube is attached to the applicator apparatus, the hole of the tube in which the tubes contents come out of, meets with the hole of the applicator apparatus. The applicator apparatus's hole is surrounded by an applicator material such as brush bristles or sponge. When the tube is squeezed, the tubes contents will come out of the hole of the applicator apparatus and be introduce onto the surrounding bristles of the brush or sponge of the applicator apparatus. The applicator apparatus attaches to a lid. The top portion of the lid has an opening in which the applicator apparatus can be placed into. The bottom portion of the lid can have a suction cup base that is to be secured onto a flat hard surface or a pull tab that can be taken off by a humans mouth. The combination of the applicator apparatus working with the lid allows for a human to perform the entire application process without contaminating ones hand with the tubes contents, and while only using one hand.

### RELATED APPLICATIONS

This application claims the benefit of provisional patent application Ser. No 61/278,656 filed on Oct. 13, 2009 by the present inventor, Alina Kravchenko.

### FEDERALLY SPONSORED RESEARCH

Not Applicable.

### SEQUENCE LISTING OR PROGRAM

Not Applicable.

### BACKGROUND OF THE INVENTION

1. Field of the Invention

The present invention relates to the application of creams, partially the diaper rash cream, specifically to improve the application process by eliminating certain steps to make the application process more efficient, hygienic and safer.

2. Prior Art

The present method for applying creams and the like for treating diaper rash essentially are manual direct application using the hands of the applier. In particular, cream or ointment used to treat the diaper rash is placed on the hands of the applier or directly on the skin of the baby and is spread about the skin of the child using the hand of the applier.

The process usually involves about six steps to compete the process. These steps are Step (1) pick up the diaper rash tube. Step (2) use one hand to hold the tube of cream and the other hand to open the top lid. The Problem with step two is that, by having to use two hands the applier will not be able to hold the child steady, thus creating an opportunity for the child to either fall or move about the area. Step (3) squeeze the cream onto either the area desired or on to the appliers fingers, and spread the cream around. The problem(s) associated with the third step is that the applies fingers get contaminated with the diaper rash cream, thus making it possible to stain other undesirable areas with the contaminated hand (such as clothing or the diaper area). Another problem of using one fingers to spread the cream is that there is chance of transferring bacteria on the hands of the applier to the skin of the child. In addition it is also difficult to spread the cream into the crevices, folds and creases of the baby's body, and it also becomes difficult to create an even distribution of the cream onto the skin of the child. Step (4) use one hand to hold the tube of cream and the other hand to close the top. Step (5) place the cream down on the changing station or store it away. The problem with step five, is that if the tube of creams placed on the changing area it opens the possibility for the child to either knock it off onto the floor or grab for it. If it is placed away, it causes this step to be more time consuming, by having to reach or look for it. Step (6) wipe or wash the cream off the appliers fingers, which will be necessary if the applier used his or her hand to spread the cream. The Problem with step six: is that the waterproof components of most diaper rash creams takes more effort and thus more time to get the cream off the appliers fingers. Using soap and water or a wet wipe is usually necessary to get the cream fully off. In order to get access to a sink while in the middle of a diaper change will be difficult and the need to use a wet wipe will become a constant waste over time. Based on all the problems related to steps one through six the direct manual application method is undesirable.

To overcome these problems, products have been provided which include a foam pad for spreading out and applying the cream or ointment to the skin of the baby. However, even while utilizing the foam pad, the cream or ointment still the problems remain unresolved for: still requires the use of both hands, leaves the cream loosely on the changing areas surface and creating a chance for the tube to fall on the floor or for the child to grab it. Still further, such pads are typically circular and therefore, do not fit in easily into the crevices, folds and creases of the baby's body.

Another product that attempts to fix some of these problems is the anti-diaper rash cream from an applicator, inventors: Goldberg; David (Marina Del Rey, Calif.) application Ser. No. 09/640,325 Filed: Aug. 16, 2000. Which fixes some of the problems associated with the manual application method. But it still leaves the problems of leaving the cream loosely on the changing areas surface, thus creating a chance for it to fall on the floor or the child grabbing it. In addition it also requires the use of both hands to open and close the cream applicator. Furthermore this type of dispenser is not reusable, so the applier is limited to purchasing only the type of cream that comes from an applicator. In other words, after the cream from an applicator is empty, it is then thrown away and can not be reused.

### SUMMARY OF THE INVENTION

Accordingly, it is a general object of the present invention to provide a method and apparatus for the application process of creams which overcomes the disadvantages of the prior art.

In particular, it is an object of the present invention to provide a method of applying a diaper rash cream wherein (1) there is no need to use two hands, and as a result be able to hold the child steady. (2) Have easy access to the tube of cream. (3) Provide a sturdy and secure way to keep the lid in place while the applier is using the tube of cream, to prevent the child from grabbing or knocking it off on to the floor. (4) Prevent the appliers hands getting in contact with the cream. (5) Keep the applier from contaminating any undesirable area with the cream. (6) Allow an even distribution of the cream onto the skin. (7) Enable the diaper rash cream to better fit into the crevices, creases and folds of the child's skin. (8) Make it possible to reuse the apparatus on virtually any tube of cream.

The present invention eliminates several steps from the application process and solves all the problems that are associated with the application process, consisting of two parts working together. The first part is the APPLICATOR apparatus, this part is to be twisted on to the tube of cream of the proper size after the original (prior art) cap has been removed. The tube is not part of the invention, but works with the invention as a handle and dispenser. It is indicated with broken lines throughout the illustrated drawings. The APPLICATOR apparatus has an hole in which the contents of the tube come out of, this hole surrounded by brush bristles. This allows the user to squeeze a desired amount of cream which will come out from between the brush bristles, thus covering them in the content. Once the desired amount of cream has been squeezed from the tube; the user can continue to use the tube as a handle and swipe the desired area with the brush bristles. The shape and material of the bristles easily fits into the crevices, folds and creases of the baby's body, creates an even distribution of the cream to the child's skin, while easily keeping the the appliers hands clean of the cream. Thus eliminating the chance of transferring bacteria from the applier to the baby and the need to clean the appliers fingers of the cream.

Part two is the LID; which consists of an open top in which the APPLICATOR is to be placed into and an enclosed bottom with a suction cup attached to it. This suction cup is to be firmly pressed onto a flat hard surface to created a secure seal between the suction cup and the table. This will keep the LID secured onto the flat hard surface area, and leave the open part of the LID in the upright position. The secured LID allows for the APPLICATOR to be snapped into or out of the it while using only one hand. In addition when the APPLICATOR is not in use and is placed into the LID; the suction cup seal between the lids base and a flat hard surface will prevent the child from knocking the present invention attached to the tube secured to the flat hard surface. Thus preventing the child from knocking it off the changing surface area.

The combination of the APPLICATOR (that can be attached to a tube) and the LID (with the suction cup bottom) working together contributes to and over all easier, cleaner and faster way (1) to open and close the LID to and from the APPLICATOR, while using only one hand. (2) Enabling the applier to keep one hand on the child during the application process. (3)The APPLICATOR apparatus working along with the LID allows for one to reuses it when the tube becomes empty of its contents, so the user is not limited to using only one type of brand of cream. Overall with part one the APPLICATOR and part two the LID working together with any tube of cream that properly fits, creates an easier and cleaner application process, that solves all the problems of the prior art.

### BRIEF DESCRIPTION OF THE FIGURES OF THE DRAWINGS

The above mentioned features and objects of the present invention will become more apparent from the following description, taken along with the accompanying drawings where each reference numeral denote like elements and in which:

FIG. 1A is a straight perspective view of the tube detached from the prior art: cap, with the lid of the cap in the open position.

FIG. 1B is a slight bottom perspective view of the tube attached to the prior art: cap, with the lid of the cap in the open position.

FIG. 2A is a straight perspective view of the APPLICATOR about to be attached to the tube. The broken lines illustrating a tube are for illustrative purposes and are not the invention.

FIG. 2A.1 is a straight perspective view of the APPLICATOR with a sponge in replace of brush bristles.

FIG. 2B is a straight perspective view of the APPLICATOR (that is attached to a tube). The broken lines illustrating a tube are for illustrative purposes and are not the invention

FIG. 2B.1 is a straight perspective view of the APPLICATOR attached to a handle in replace or the tube.

FIG. 2C is a side perspective view of the APPLICATOR (that is attached to a tube).

FIG. 2D is a perspective cross sectional view taken along line 2D-2D of the APPLICATOR (that is attached to a tube) of FIG. 2C

FIG. 2E is a straight perspective view of the APPLICATOR with one side of the brush bristles attached and the other side detached.

FIG. 2F is a separate close up view of the lower middle part of APPLICATOR of FIG. 2E, indicated buy the broken up line c.

FIG. 2F.1 is a separate close up view of the lower middle part of APPLICATOR of FIG. 2E with the contents of the tube coming out, indicated buy the broken up line c.

FIG. 2G is a bottom plan view of the APPLICATOR, only without the brush bristles.

FIG. 2H is a separate close up view of the middle part of the bottom plan view of the APPLICATOR of FIG. 2G, indicated buy the broken up line b.

FIG. 2I is a side perspective view of the APPLICATOR with one side of the brush bristles about to be attached to the APPLICATOR of FIG. 2E.

FIG. 2J is a perspective cross sectional view taken along line 2J-2J of the APPLICATOR of FIG. 2I

FIG. 2K is a separate close up view of the bottom middle part of the perspective cross sectional view of the APPLICATOR of FIG. 2J, indicated buy the broken up line f.

FIG. 2L is a separate close up view of the top left part of the cross sectional view of the APPLICATOR of FIG. 2J, indicated buy the broken up line d.

FIG. 2M is a separate close up view of the top right part of the cross sectional view of the APPLICATOR of FIG. 2J, indicated buy the broken up line e.

FIG. 3A is a slight bottom perspective view of the LID with the suction cup bottom about to be attached onto a flat hard surface.

FIG. 3B is a straight perspective view of the LID with the suction cup bottom sealed with the flat hard surface.

FIG. 3B.1 is a straight perspective view of the LID with the suction cup bottom sealed with the flat hard surface, with an item placed inside.

FIG. 3C is a top plan view of the LID with a suction cup bottom sealed to a flat hard surface of FIG. 3B.

FIG. 3D is a slight bottom perspective view of the LID with a suction cup bottom detached from the lids base.

FIG. 3E is a straight perspective view of the LID with a suction cup bottom detached from the lids base.

FIG. 3F is a perspective cross sectional view taken along line 3F-3F of the LID with a suction cup bottom detached of FIG. 3E.

FIG. 3G is a separate close up view of the left side of the cross sectional view of the LID with a suction cup bottom of FIG. 3F, indicated buy the broken up line g.

FIG. 3H is a separate close up view of the right side of the cross sectional view of the LID with a suction cup bottom of FIG. 3F, indicated buy the broken up line h.

FIG. 4A is a straight perspective view of the APPLICATOR (that is attached to a tube) and placed into the LID with the suction cup bottom attached onto a flat hard surface. The broken lines illustrating a TUBE are for illustrative purposes.

FIG. 4B is a side perspective view of the APPLICATOR attached to the LID (with a suction cup bottom)

FIG. 4C is a perspective cross sectional view taken along line 4C-4C of the APPLICATOR attached to the LID of FIG. 4B

FIG. 4D is a separate close up view of the bottom middle part of the LID of FIG. 4C, indicated buy the broken up line k.

FIG. 4E is a separate close up view of the left side of the APPLICATOR attached to the LID of FIG. 4C, indicated buy the broken up line i.

FIG. 4F is a separate close up view of the right side of the APPLICATOR attached to the LID of FIG. 4C, indicated buy the broken up line i.

FIG. 5A is a slight bottom perspective view of another version of the APPLICATOR about to be attached to the tube. The dashed lines illustrating a tube are not part of the invention.

FIG. 5B is a side perspective view of another version of the LID, with a pull tab bottom instead of a suction cup bottom.

FIG. 5C is a slight top perspective view of another version of the APPLICATOR.

FIG. 5D is a straight perspective view of the APPLICATOR (that is attached to a tube, illustrated by the broken up line) snapped in place with the LID (with pull tab bottom).

FIG. 5E is a straight perspective view of the APPLICATOR connected to the LID (with a pull tab bottom), by an attachment flap; with the LID in the open position.

FIG. 5F is a straight perspective view of the APPLICATOR connected to the LID (with a pull tab bottom), by an attachment flap; with the LID in the closed position.

FIG. 6A is an illustration of step one of how to assemble the APPLICATOR, indicating a human to remove the original cap from the tube and attach the APPLICATOR of the present invention onto the tube.

FIG. 6B is an illustration of step two of how to assemble the LID (with the suction cup bottom), indicating a human to place the bottom of the suction cup onto a flat hard surface and press down on the LID to create a tight seal with the flat hard surface.

FIG. 6C is an illustration of step three of how to assemble the APPLICATOR and LID (with the suction cup bottom), indicating a human to snap the APPLICATOR into the opening part of the LID.

FIG. 7A is an illustration of step one of how to use the APPLICATOR and LID (with the suction cup bottom), indicating a human hand pulling the tube that is attached to the APPLICATOR from the LID. (Note: The LID will remain on the flat hard surface due to the suction cup bottom being secured on to a flat hard surface and attached to the lids base)

FIG. 7B is an illustration of step two of how to use the APPLICATOR, indicating a human hand to squeeze a desired amount of the tubes contents, that will come from between the brush bristles of the APPLICATOR.

FIG. 7C is an illustration of an alternative to step two of how to use the APPLICATOR, indicating a human hand to dip the brush bristles of the APPLICATOR into any desired container and its contents.

FIG. 7D is an illustration of step three of how to use the APPLICATOR, showing a human hand swiping the brush bristles covered by the tubes contents onto a desired surface area.

FIG. 7E is an illustration of step four of how to use the APPLICATOR and LID, indicating a human hand placing the tube that is attached to the APPLICATOR into the LID.

FIG. 8A is an illustration of step one of how to use the APPLICATOR and LID (with a pull tab bottom), indicating a human hand pulling on the pull with one hand while holding the tube that is attached to the APPLICATOR with another hand.

FIG. 8B is an illustration of step two of how to use the APPLICATOR, indicating a human hand to squeeze a desired amount of the tubes contents, that will come from between the brush bristles of the APPLICATOR. (Note: This is the same step that is illustrated in FIG. 7B).

FIG. 8C is an illustration of step three of how to use the APPLICATOR, showing the hand swiping the brush bristles covered by the tubes contents onto a desired surface area. (Note: This is the same step that is illustrated in FIG. 7D).

FIG. 8D is an illustration of step four of how to use the APPLICATOR and LID (with a pull tab bottom), indicating a human hand to hold the tube that is attache dot the APPLICATOR with one hand, while placing the LID over the APPLICATOR with the other hand.

FIG. 8E is an illustration of an alternative of step one and step four one of how to open and close the LID to and from the APPLICATOR, using the teeth in replacement of the other hand.

### DETAILED DESCRIPTION OF PREFERRED EMBODIMENT

There are many variations for the present inventions many parts; ranging in various sizes, materials, shapes, and ways of working together and connecting to each other. In the following description I will be describing the preferred embodiment for the present invention. These should not limit the present invention in any way, because other sizes, shapes, materials and ways of connecting to each other, for each part are also satisfactory.:

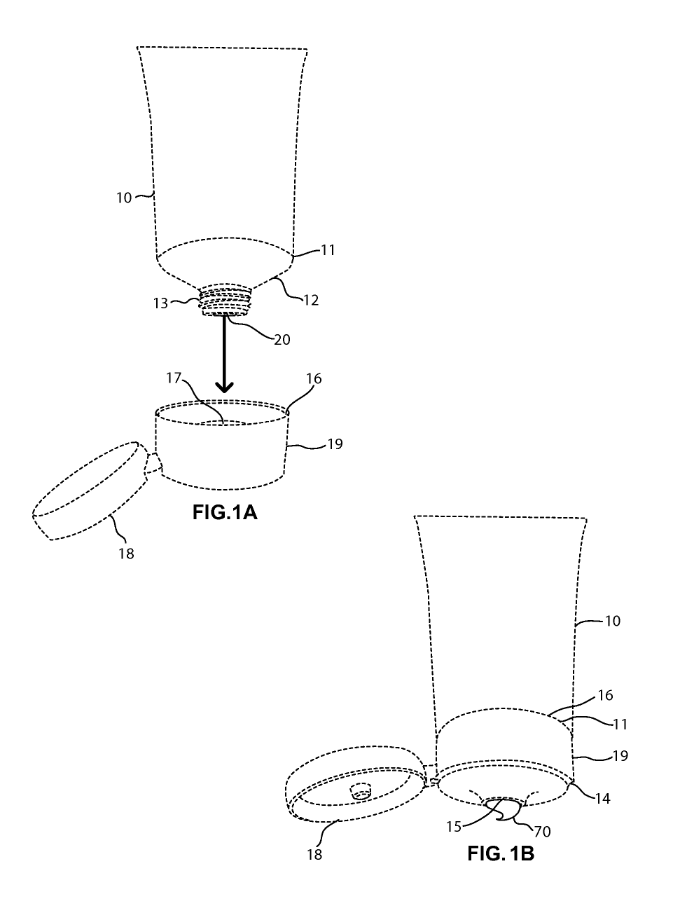

First, it is essential to understand the structure and function of all the parts of the Prior Art, to better understand the function of the preferred embodiment of the present invention. In the case of the present invention, the prior art is the cap of a tubular structure, this prior art cap is to be removed from the tube and replaced with the APPLICATOR part of the present invention. There are many types of various tubular structures ranging in various shapes and sizes. That is why the present invention can alter its many parts to fit the many variations of the shapes and sizes of the many types of tubular containers. In FIGS. 1A and 1B I have illustrated by broken up lines, a generic type of tubular structure and its prior art cap and caps lid. FIG. 1A is a straight perspective view of the tube detached from the prior art cap, with the lid of the cap in the open position and FIG. 1B is a slight bottom perspective view of the tube attached to the prior art cap, with the lid of the cap in the open position. The top portion of the tube is the tubes body 10, indicated by a broken up line. The tubes body 10 is usually made up from a thinner bendable plastic or aluminum lightweight material. The elongated cylinder/triangular like shape (with a closed straight top) allows for the tubes body 10 to be used as a handle. The thinner bendable plastic or aluminum material in which is commonly used to make the tubes body 10 allows for it to become flexible. This flexibility allows for a desired amount of the tubes contents such as cream 70 to come out of the tubes hole 20, depending on how much pressure is put on the tubes body 10. The lower portion of the tube is usually made up of a harder plastic or aluminum than that of 10 tubes body. These parts include: the base of tubes body 11, bottom of the tube 12 male threads, 13 and tubes hole 20. The base of tubes body 11 has about the same sized circular circumference as the interior top rim 16 of the prior art cap. This is because the tubes body 11 and interior top rim 16 of the prior art cap are meant fit with each other as seen in FIG. 1B. The bottom of the tube 12, which can be seen in FIG. 1A, typically has the same circular circumference as the base of tubes body 11 at the top and gradually gets narrower as it progresses downwards to meet with the same sized circular circumference of the top of the male threads 13 of the tube. Inside of the middle top part of the prior art cap are the female threads 17. Both the female threads 17 and the male threads 13, can vary in many shapes and sizes in order to properly fit together by interlocking their opposite ridges, thus creating a secure seal with one another. Once the female threads 17 and the male threads 13 have been secured together, the bottom 12 of tube will fit into the hollow part of inside of the cylindered shaped part of the caps body 19. The bottom rim 15 of the prior art cap has a circular circumference that protrudes slightly from the cap. In the center of the bottom rim 15 which is a hollow hole in which the 70 cream or the contentions of the tube comes out of. The part that is designed to cover this hole to prevent the cream 70 from spilling out is the prior art lid. This prior art lid is designed to snap in place with the cap of the prior art. The way this happens is because the bottom rim indention 14 having slightly smaller circular circumference then that of the exterior body 19 and the same circular sized circumference as the interior rim 18 of the caps lid. This will allows for the interior rim 18 of the prior art lid to fit around the bottom rim indention 14 of the prior art cap, when the lid of the prior art is placed over the cap of the prior art.

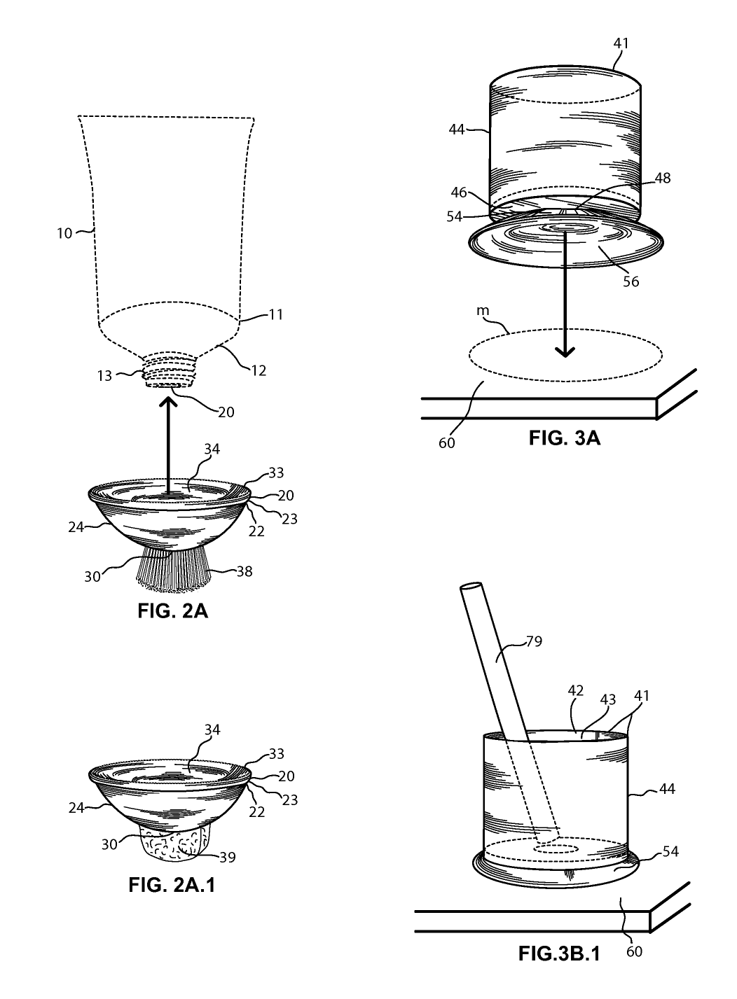

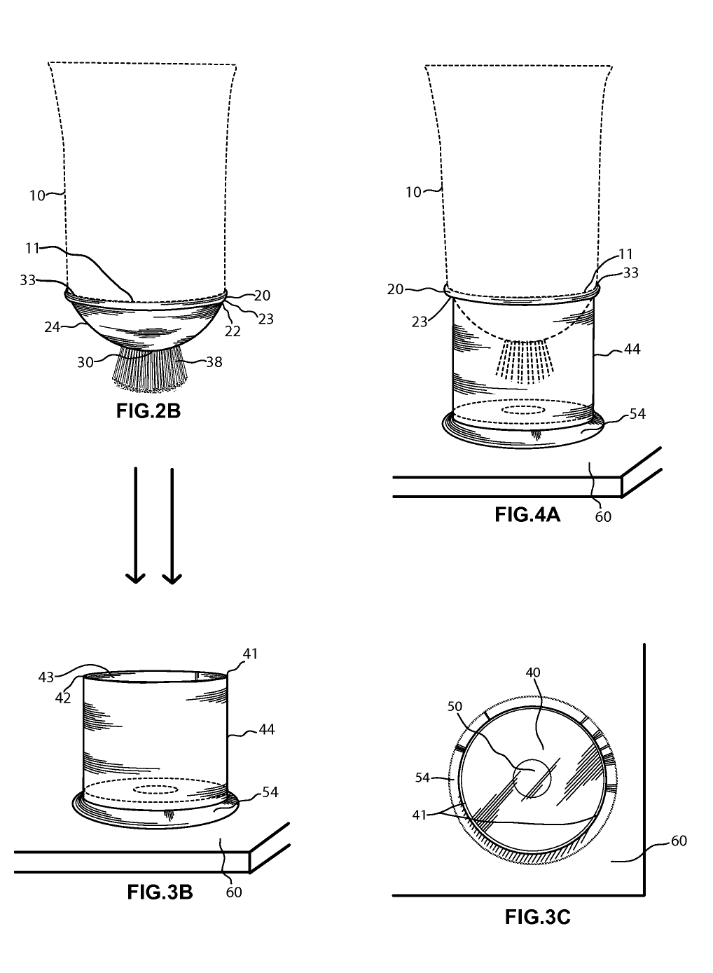

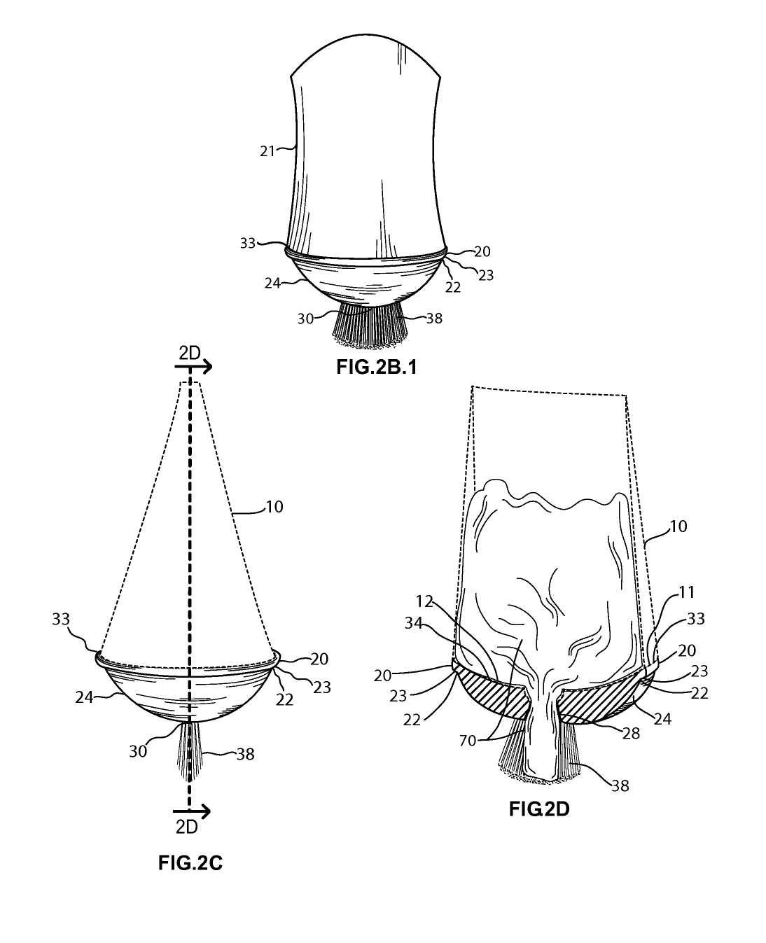

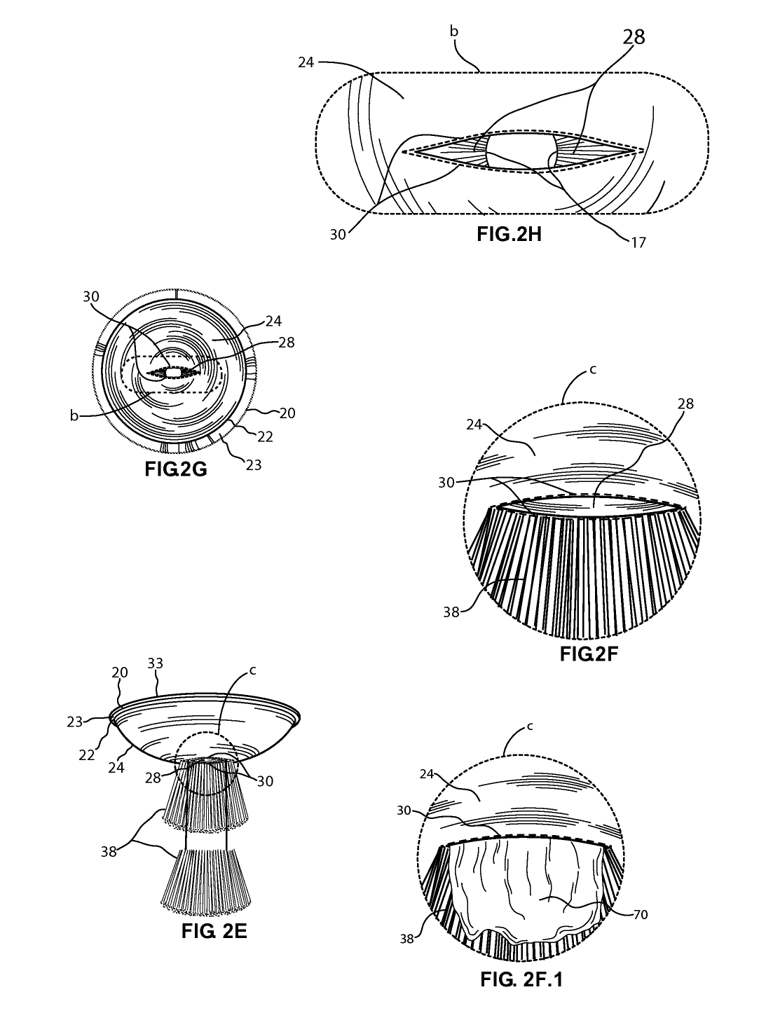

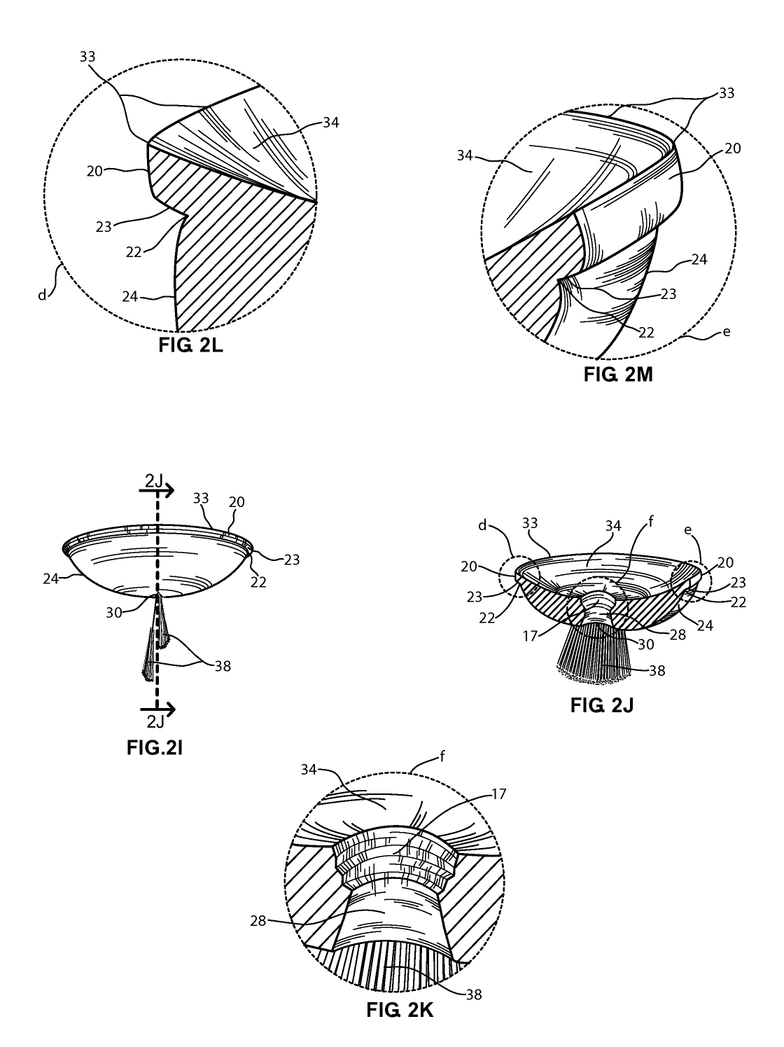

The Prior Art Cap is to be removed from the tube (usually by untwisting the male threads 13 from the female threads 17). Then the present inventions APPLICATOR is to be attached to the TUBE. Referring to FIG. 2A which shows a straight perspective view of the APPLICATOR about to be attached to the TUBE. The broken lines illustrating a TUBE are for illustrative purposes and are not the invention. In this figure you can see that the inside surface 34 is the opposite shape of the bottom 12 of the tube and you can also see that the top rim 33 of the applicator and the base of tubes body 11 mirror each other. This is because both the inside surface 34 and the bottom of tube 12 are meant to fit with one another and the the top rim of applicator 33 is supposed to be pressed against the base of tubes body 11. You can better see these connections by referring to FIG. 2D which illustrates a perspective cross sectional view taken along line 2C-2C of the APPLICATOR attached to a TUBE of FIG. 2C. In FIG. 2D you can especially see how the bottom 12 of the tube becomes flush with the inside surface 34 of the APPLICATOR.

To better understand how the bottom portion of the tube interlocks and is able to stay in place with the APPLICATOR take a look at FIG. 2J which shows a perspective cross sectional view taken along line 2J-2J of the APPLICATOR of FIG. 2I. Keep in mind that FIG. 2J only shows half of the APPLICATOR, and that the other half of the APPLICATOR looks the same. In FIG. 2J you can also see the shape and size of the inside surface 34 of the APPLICATOR, which starts out wider at the top where it meets with the top rim 33 of APPLICATOR and gets narrower as it progresses downward towards the top of the female threads 17 of the applicator. Although the inside surface 34 of the APPLICATOR can be hollow, in the preferred embodiment, as I mentioned before the inside surface 34 of the APPLICATOR mirrors after the bottom 12 of the tube; this is because when the male threads 13 of the tube are twisted in place with the female threads 17 of the APPLICATOR; the shape of the bottom 12 of the tube, fits snugly together with the inside surface 34 of the APPLICATOR, which can be seen by referring back to FIG. 2D.

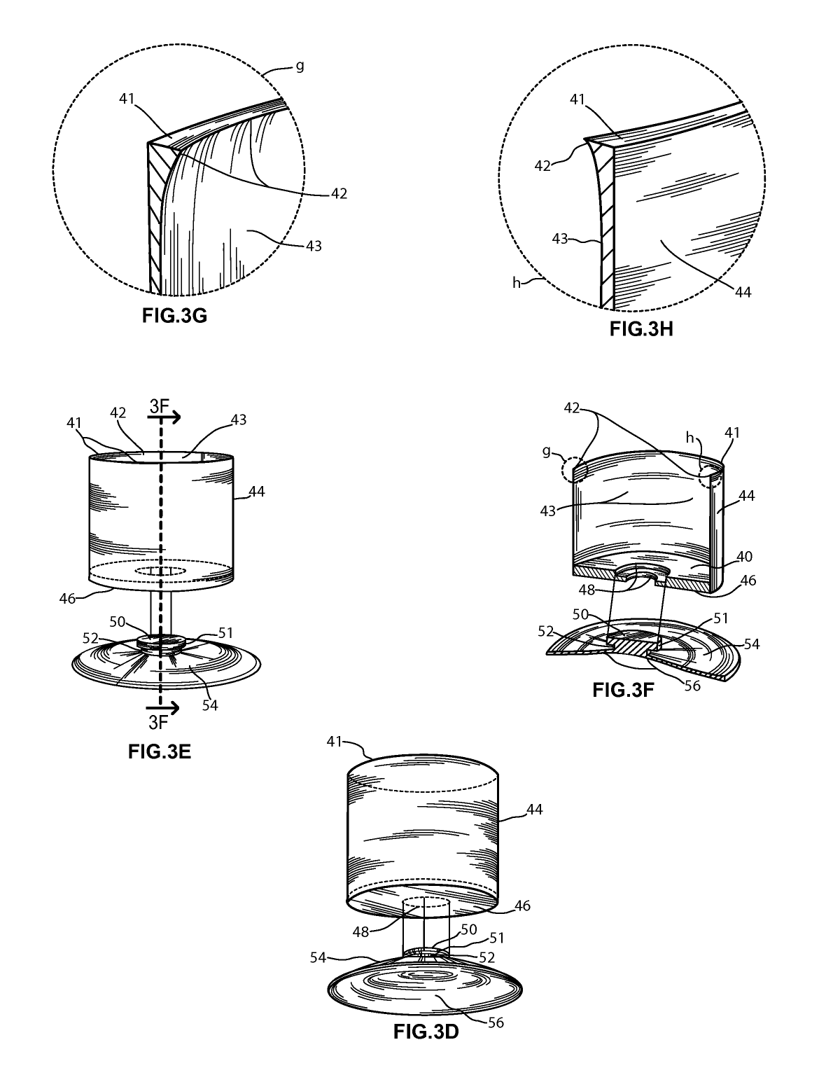

After the present invention APPLICATOR has been properly attached to the TUBE you can see by referring to FIG. 2B which shows a straight perspective view of the APPLICATOR attached to the TUBE. Here you can see how the top rim 33 of the APPLICATOR and 11 base of tubes body fit snugly together. The broken lines illustrating a TUBE are for illustrative purposes and are not the invention. There are many shapes that the APPLICATOR (and its LID) can take form, in the preferred embodiment, the rim of the 33 APPLICATOR is to has a circular circumference that goes all the way around the very top exterior of the APPLICATOR and that is to range in size to meet the various sizes of the base of tubes body 11. In order to better see the circular circumference of the APPLICATOR take a look at FIG. 2G, which illustrates a bottom plan view of the APPLICATOR, (only without the brush bristles) and to see the top plan view of the LID refer to FIG. 3C, which is a top plan view of the LID with a suction cup bottom sealed to a flat hard surface of FIG. 3B. The circular circumference of the APPLICATOR and the LID can also be in a square, diamond, pentagon, rectangle, oval, octagon, parallelogram and any other shape. The reasons why I chose a circular circumference for the APPLICATOR and the LID are because: (a) The common shape for the bottom portion of the tube is that of a circular circumference shape as seen in FIG. 1A, and as a result it is preferred that the present invention is also in a circular shape to better fit with the bottom portion of the tube.

Referring to FIG. 2K which shows a separate close up view of the bottom middle part of the perspective cross sectional view of the APPLICATOR of FIG. 2J, indicated by circular broken up line labeled f. Keep in mind that because FIG. 2K is a close up cross sectional view of the APPLICATOR, the illustration only shows one half of the interior including the inside surface 34, female threads 17 and the hole interior rim 28 of the APPLICATOR, and that the other half of the APPLICATOR looks the same as the one illustrated in FIG. 2K. In FIG. 2K you can see one half of the female threads 17 of the APPLICATOR, the size and shape of the female threads 17 can vary depending on the size of the male threads 13 of the tube. The reason why I have used the exact same female threads 17 in the preferred embodiment of the APPLICATOR part of the invention as that of the Prior Arts caps; is because both of the female threads 17 are in the proper size and shape to fit with the male threads 13 of the tube. As I have mentioned before, the size of both the female 17 and male 13 threads can vary in many shapes and sizes; and that I have illustrated the most generic types in order to illustrate how the tube is to be connected and secured to the APPLICATOR apparatus part of the invention. Like most female threads, the generic ones that I have illustrated have circular shaped ridges in which the male threads 13 that have opposite circular ridges which are to be twisted in place with the frame threads 17, and as a result of interlocking their opposite circular ridges, creating a tight and secure seal with one another.

Keep referring to FIG. 2K, and you will find below the female threads 17 of the APPLICATOR is the hole tunnel 28 of the APPLICATOR. Keep in mind that in FIG. 2K you are looking at a cross section of the APPLICATOR, and that the other half looks identical. The very top of the hole tunnel 28 of the APPLICATOR, has the same shape and circumference size as the bottom part of the female threads 17 and the hole tunnel 28 gradually gets narrower at one side and wider at the opposite side as it progresses down to meet with the size and shape of the hole rim 30 of the APPLICATOR. This hole tunnel 28 can take many shapes and sizes and even be eliminated from the APPLICATOR altogether. The hole rim 30 of the applicator can range from any such shape as round, oval, square, rectangular and so on. In the preferred embodiment I have added the hole tunnel 28 because I feel that the very narrow almond like shape (with pointy edges), that the hole tunnel 28 creates toward the bottom of the APPLICATOR, will allow both sides of the brush bristles 38 to be flush with one another when they are attached to the hole rim 30 of the APPLICATOR. You can refer to FIG. 2I to see a side perspective view of the APPLICATOR with one side of the brush bristles 38 about to be attached to the hole rim 30 of the APPLICATOR. Once the brush bristles 38 have been attached to the hole rim 30 of the APPLICATOR you can refer to FIG. 2C, which illustrates a side perspective view of the APPLICATOR attached to a TUBE. You can see that both sides of the brush bristles 38 lie flat with each other (and are wide at the other side) because of the very narrow shape of the hole rim 30 at one side and wide shape at the other. When the cream 70 is pushed through the hole rim 30 of the APPLICATOR the very narrow almond shape of the hole rim 30 will allow for the cream 70 to come out from between the brush bristles 38 in a flat thin like way as seen in FIG. 2D is a perspective cross sectional view taken along line 2D-2D of the APPLICATOR attached to a TUBE of FIG. 2C.

In order to better see the very narrow almond like shape of the bottom of the hole tunnel 28 and the hole rim 30 of the APPLICATOR, I have illustrated a bottom plan view of the APPLICATOR with the brush bristles 38 removed refer to FIG. 2G. The broken up line going around the middle of the bottom plan view of FIG. 2G of the applicator is indicated by the letter b, and is blown up in a separate close up view and is labeled as FIG. 2H. In FIG. 2H you can better see the very narrow almond shape (with pointy sides) in which the base of the hole tunnel 28 has turned into. Around the hole tunnel 28 is the hole rim 30 of the APPLICATOR and it is represented by broken up lines indicating where the brush bristles 38 are to be placed. Although there a number of ways in which the brush bristles 38 can be attached to the APPLICATOR, I feel that placing the brush bristles 38 around the hole rim 30 of the APPLICATOR will provide a better and more efficient application process. As I have mentioned before, the shape of the hole rim 30 of the APPLICATOR is wide on one side and very narrow at the other and as a result its shape will allow the brush bristles 38 to be very flat at one end and very narrow at the other. The wider part of the brush bristles 38 will allow for more area to get covered with the brush bristles 38 contents such as the cream 70, in a shorter amount of time, while maximizing the brush bristles 38 to their full potential. Further more without wasting on the material of excess brush bristles 38.

Referring to FIG. 2E, which is a straight perspective view of the APPLICATOR with one side of the brush bristles attached and the other side detached. The reason why one side of the brush bristles 38 have been removed from one side of the hole rim 30, is because to better illustrate how the brush bristles 38 attach to the hole rim 30 and to show the very narrow almond like shape of the hole rim 30 of the APPLICATOR. Take a look at the circular broken up line c indicating to the lower middle of the applicator with one side of the brush bristles removed, taken from FIG. 2E and is blown up in a separate labeled FIG. 2F. In FIG. 2F you can see a little bit of the bottom part of the hole tunnel 28 and especially the way the hole rim 30 surrounds the bottom part of the hole tunnel 28 of the APPLICATOR. In order to better see the shape that cream 70 takes, refer to FIG. 2F.1. In which you can see how the wide shape of the hole rim 30 at one end and the narrow shape of the hole rim 30 at the opposite side, allows for the cream 70 to come out in a very flat and wide way, as I mentioned before.

Although there are many various types of materials that could be placed around the hole rim 30 of the APPLICATOR in a number of various ways, and the present invention could still fix all of the problems that are associated with the prior art. For example a sponge like material can take place of the brush bristles 38 and be placed in any way shape or for around the hole rim 30 of the APPLICATOR. You can see the sponge 39 in place of the brush bristles 38 by referring to FIG. 2A.1 which is a straight perspective view of the APPLICATOR with a sponge bottom. There is no limit to what can take place of the brush bristles, so long that whatever the object is; it is capable of beige used to apply a desired amount of cream 70 (or any other preferred content) onto any desired surface area. If brush bristles 38 are used, the range in the types of bristles can also vary. From natural hairs to synthetic fibers, such as silicone, rubber, plastic and the likes. In the preferred embodiment I feel that there is more of a benefit if the brush bristles 38 are made out of soft synthetic fiber bristles. This is because unlike the sponge which will absorb the cream 70, the synthetic fiber bristles will not. Another benefit is that most synthetic fibers bristles are generally soft and silky to the touch and relatively inexpensive compared to other types of bristles, such as animal hairs. In addition, the synthetic fiber bristles of the brush bristles 38 will also allow an even distribution of the cream 70 when swiped on the desired surface.

In order to understand how and where the brush bristles 38 are to be attached to the hole rim 30 of the APPLICATOR take a look at FIG. 2E and FIG. 2I which shows a side perspective view of the APPLICATOR with one side of the brush bristles about to be attached to the APPLICATOR. Let me first mention that there are many ways in which 38 brush bristles can be attached to the APPLICATOR, and in the preferred embodiment I feel that placing the top portion of the brush bristles 38 into the hole rim 30 of the APPLICATOR while the material in which the entire APPLICATOR is made out of is still in liquid form. Note that all of the various parts of the APPLICATOR could be made out of most sturdy materials such as wood, light weight metals (like aluminum), and plastic. In the preferred embodiment I feel that plastic is the more desirable material, because most plastics are relatively cheaper to reproduce then other materials. In addition most plastics also usually start off being in a liquid state, this liquid state allows the liquid plastic to be poured in a desired mold, such as the mold of the APPLICATOR. Then when the plastic hardens it takes shape of its mold. This liquid state allows for the top portion of the brush bristles 38 to be placed into the hole rim 30 of the APPLICATOR (as I mentioned before). The plastic (while in liquid form) will surround the space between the the brush bristles 38 and when the plastic material hardens it will act like a seal securing the brush bristles 38 in place with the hole rim 30 of the APPLICATOR. A glue could be placed in between the top portion of the brush bristles 38 where they meet with the hole rim 30 of the APPLICATOR, to ensure an even and more secure attachment.

Once the brush bristles 38 have been secured into the hole rim 30 of the APPLICATOR, as a result the brush bristles 38 will mimic the shape of the hole rim 30 of the APPLICATOR. Which is wide at one side and narrow at the other. In the side view of the APPLICATOR shown in FIG. 2C, you can see the brush bristles 38 are narrow and in the straight perspective view of the APPLICATOR shown in FIG. 2B, you can see that the brush bristles 38 are wide. (Note: In both FIGS. 2B and 2C, the broken lines illustrating a TUBE are for illustrative purposes and are not the invention). Once 38 brush bristles have been attached to 30 hole rim of applicator, the bottom of 38 brush bristles could be trimmed into a rounded like shape as seen in both FIG. 2A and FIG. 2B. In both of these figures you can see 24 outer exterior of applicator, which is in a dome like shape that starts out the same size where it meets with 30 hole rim of applicator and gradually gets wider in a circular circumference where it meets with 22 inner corner indention of the APPLICATOR.

Thee are many ways in which the APPLICATOR and the LID can be attached and detached to and from another. In the preferred embodiment they are snapped together; thus creating an air tight seal in order to prevent contaminating the brush bristles 38 of the APPLICATOR, when the APPLICATOR is not in use. In order to better understand how this is possible, lets first look at all the parts of the top portion rim of the APPLICATOR. Referring to FIG. 2L (which is indicated by a broken up line d) and 2M (which is indicated by a broken up line e) which show a separate close up view of the top left and right sides of the perspective cross sectional view of the APPLICATOR of FIG. 2J. Although you can only see the right and left of the APPLICATOR, keep in mind that all the parts and the connections go all the way around the entire perimeter of both the APPLICATOR. In FIGS. 2L and 2M you can see the inner corner indention 22 of the applicator; this is the corner where the bottom rim 23 and the outer exterior 24 of applicator meet. The circumference of the inner corner indention 22 of the applicator is circular, which is slightly smaller in size then the top part (or the largest circumference size part) of the outer exterior 24 of applicator. The result of the smaller circumference of the inner corner indention 22 compared to the outer exterior 24 of applicator, creates an indention between the bottom rim 23 of applicator and the outer exterior 24 of applicator. The inner corner indention 22 of applicator has the same circumference as the tip of the lip interior 42 of the lid. This is because both parts are meant to fit together when the APPLICATOR is attached to the LID. The bottom rim 23 of applicator acts as a support for the top rim 41 of the lid to sit on. The size and shape of the bottom rim 23 of the applicator can range; in the preferred embodiment the bottom rim 23 of applicator is in the shape and size that mimics the top rim 41 of the lid. This is because both parts are designed to become flush with one another when the APPLICATOR is attached to the LID.

Now lets look at all the parts of the top parts of the LID that are to be attached to the APPLICATOR. Referring to FIG. 3G (which is indicated by a broken up line g) and FIG. 3H (which is indicated by a broken up line h), which are separate close up views of the right side and left side of the LID with a suction cup bottom of FIG. 3F. Although you can only see the right and left of the APPLICATOR attached to the LID, keep in mind that all the parts and the connections of the LID go all the way around the entire perimeter of the LID. In FIG. 3G and 3H you can see the top rim 41 of the lid, which has a similar sized circular circumference as the bottom rim 23 of the applicator; as I mentioned before this is because 23 bottom rim of applicator is supposed act as a support and sit on top of 41 top rim of the LID. Towards the very top of the inner interior 43 of the lid, right below the top rim 41 of the lid, is the lip 42 interior of the lid. The very top of the lip interior 42 of the lid has the same circular shape and sized circumference as the inner corner indention 22 of the applicator, (This is because both of these parts are meant to snugly fit together, as I mentioned before.) As the lip interior 42 of the lid progresses downwards the circumference of it gets slightly wider to meet with the inner interior 43 of the lid. The inner interior 43 of the lid is about the same size in circumference as the widest part of (which is the top part) of the outer exterior 24 of the applicator.

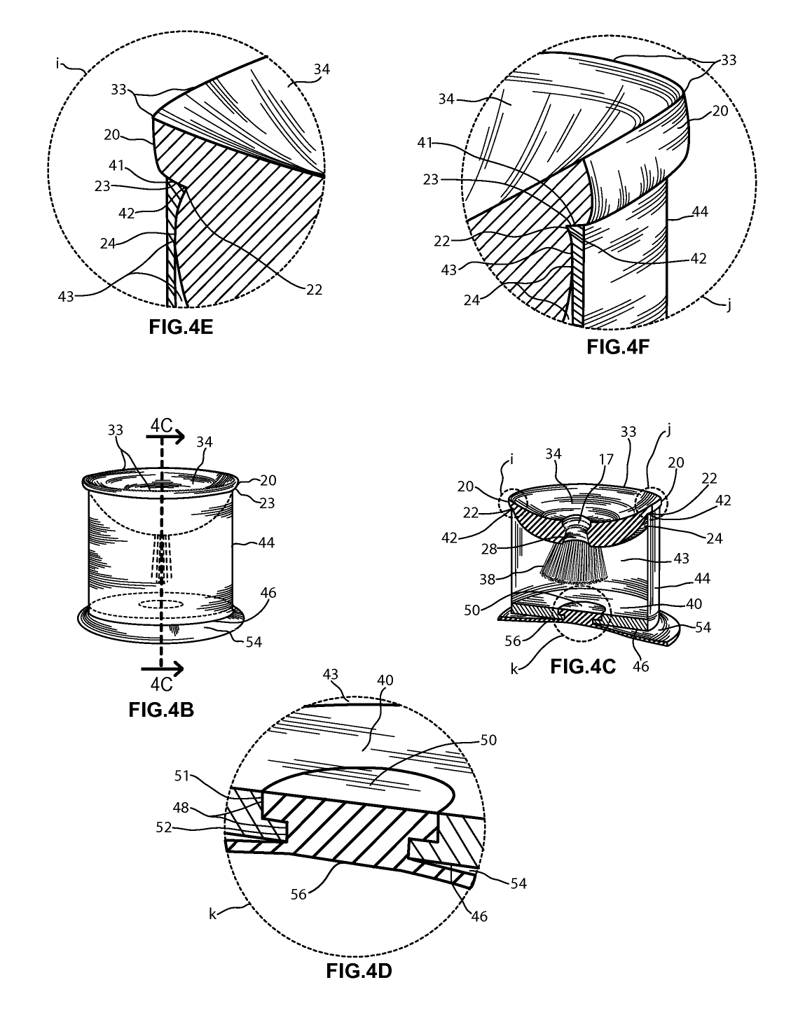

The dome shape of the outer exterior 24 of applicator, allows for the LID to fit over the APPLICATOR easier. In addition the flexible plastic material in which the LID is made out of (in the preferred embodiment) allows for the top portion of the LID to be slightly flexible; Thus allowing the lip interior 42 of the lid to slide over the the outer exterior 24 of applicator and as a result get locked in place within the inner corner indention 22 and the bottom rim 23 of applicator. In order to better see and understand how the LID is snapped onto the APPLICATOR, I have cut FIG. 4B (which is a side perspective view of the APPLICATOR attached to the LID) down the middle and I have illustrated the right half in FIG. 4C. Then I have illustrated separate close up views of the left and right sides of the top parts of the APPLICATOR attached to the LID/STAND of FIG. 4C, represented by FIG. 4E (which is indicated by a broken up line i) and FIG. 4F (which is indicated by a broken up line j). Although you can only see the right and left of the APPLICATOR attached to the LID, keep in mind that all the parts and the connections between the APPLICATOR and LID go all the way around the entire perimeter of both the APPLICATOR and the LID. In FIG. 4E and FIG. 4F, you can see how all the parts of the top part of the APPLICATOR fit with the top portion of the LID. Beginning with the bottom rim 23 of applicator, which becomes flush with and sits on top of the top rim 41 of the lid. Next, the lip interior 42 of the lid and the inner corner indention 22 of the applicator become flush with one another, because they both have the same sized circular circumferences. As I have mentioned previously, the shape of the lip interior 42 of the lid is a reflection of the inner interior 43 of lid, with the lip interior 42 of the lid projecting out and gradually getting narrower to meet with the smaller circular circumference of the inner interior 43 of the lid. In FIG. 4E and FIG. 4F, you can also see how the inner corner indention 22 of the applicator meets with the outer exterior 24 of the applicator; Because the inner corner indention 22 of the applicator is projecting in and gradually wider to meet with the larger circular circumference of the top part of the outer exterior 24 of the applicator. The result of this allows for the lip interior 42 of the lid and the top portion of the inner interior 43 of the lid to become flush with the inner corner indention 22 of the applicator and the top part of the outer exterior 24 of applicator. Above this connection is the top rim exterior 20 of the applicator, which has circular circumference that is the same as the widest part of the bottom rim 23 of the applicator and the top rim exterior 20 of applicator and gradually gets slightly wider in circumference towards the top, where it meets with the top rim 33 of the applicator.

Now that we understand all the parts of the APPLICATOR and how they attach to the LID, lets take a look at the rest of the parts of the LID in order to better understand its function as a lid and as a stand. Referring to FIG. 3E which shows a straight perspective view of the LID with a suction cup bottom detached. Here you can see below the top rim 41 of the lid is the outer exterior 44 of the lid; who's shape, size and length can take many forms. In the preferred embodiment the outer exterior 44 is in a cylinder shape which is wide and long enough to fit the outer exterior 24 of the applicator and the brush bristles 38 of the applicator inside of it. In other words, the length and size of the outer exterior 44 of the lid can vary depending on the size of the entire APPLICATOR and the length of the brush bristles 38 of the applicator. The thickness between 43 inner interior of lid and 44 outer exterior of lid can vary, but should it be thick enough to create a sturdy frame between 41 top rim of lid and the entire base of the LID, mainly to prevent it from collapsing when the APPLICATOR is attached and detached to and from the LID.

Take a look at FIG. 3D which shows a slight bottom perspective view of the LID with a suction cup bottom detached from the lids base. Here you can see that the bottom part of the outer exterior 44 of the lid is connected to the base exterior 46 of the lid. The circular circumference of the base exterior 46 of the lid could range in size and shape. In the preferred embodiment it is recommended that the circumference of the base exterior 46 of the lid is to be about the same as the outer perimeter of the top rim 41 of the lid, or wider. (The main reason for this is because it will create a sturdier base for when the suction cup is secured onto a flat hard surface, as I will later describe). Keep in mind that the circumference and shape of the outer exterior 44 of the lid can vary and change depending on the circumference size and shape of the top rim 41 of the lid and the base exterior 46 of the lid. In FIG. 3D you can see in the center of the base exterior 46 of the lid are broken up lines indicating the suction cup placement 48. The suction cup is not the invention, but it works with the present invention to secure the base of the LID to any desired flat hard surface 60 that is large enough to create an air tight seal with the suction cup. The flat hard surface 60, such as a table, side of a wall or even the ceiling of a surface; is also not part of the present invention, but works with the suction part of the invention. The harder and flatter the surface is the better the suction cup attachment will be. Suction cups can come in various sizes and types, and there is no particular type that the present invention is limited to. But it is preferred that the size of the suction cup is large enough to support the LID and the APPLICATOR (that is attached to the tube). The main reason why a larger size is recommended, is to create a wider base that will be able to prevent the APPLICATOR (that is attached to the tube), from falling over. In the preferred embodiment, I will be describing the most generic type of suction cup, although this will not limit my invention to that particular kind. Like in the generic type of suction cup the one use with the present invention is made up of a flexible rubber like material, made to create a tight seal with 60 flat hard surface. In addition the suction cup that I have illustrated has a slightly larger circumference then the base exterior 46 of the lid. You can refer to FIG. 4B, which shows a side perspective view of the APPLICATOR attached to the LID. Take a look at how the widest circumference of the outer exterior 54 of the suction cup is wider then that of the base exterior 46 of the lid.

Referring to FIG. 3E, which is a straight perspective view of the LID with a suction cup bottom detached; and FIG. 3D, which is a slight bottom perspective view of the LID with a suction cup bottom detached from the lids base. In both FIG. 3E and FIG. 3D, you can see all the parts of the suction cup which are: The top 50 of the suction cup, this is the very top of the suction cup, it has a circular circumference and a flat top. Below the top 50 of the suction cup is the top rim 51 of the suction cup, which has the same sized circular circumference as the top 50 of the suction cup. The top rim 51 of the suction cup is connected to the middle rim 52 of the suction cup. The middle rim 52 of the suction cup has a slightly smaller circular circumference than that of both the top 50 and the top rim 51 of the suction cup. The base of the middle rim 52 of the suction cup is connected to the outer exterior 54 of the suction cup. The shape of the outer exterior 54 of the suction cup is that of a very flat dome like shape, which start out having the same circular circumference as that of the bottom part of the middle rim 52 of the suction cup; and gradually gets wider in circumference to meet with the outer circular perimeter of the bottom 56 of the suction cup. In FIG. 3D you can see the bottom 56 of the suction cup, which is in a hollow dome like shape. The bottom 56 of the suction cup is designed to be pressed onto a flat hard surface, which will allow for the flexible rubber like material (in which most suctions cups are made from) to expand and create an air tight seal with any flat hard surface that is large enough to cover the perimeter of the widest part of the suction cup.

There are many ways in which the suction cup can be attached to the LID, and there is no particular way that limits the invention. In the preferred embodiment in order to better understand how the suction cup is attached to LID, take a look at FIG. 3F which illustrates a perspective cross sectional view taken along line 3F-3F of the LID with a suction cup bottom detached, of FIG. 3E. Keep in mind that FIG. 3F shows half of the LID and half of the suction cup, and that the other half looks the same. In FIG. 3F you can see how the bottom part of the inner interior 43 of the lid is connected to the base interior 40 of the lid; and as a result the base interior 40 of the lid has a circular circumference that similar to that of the inner interior 43 of the lid. The thickness between the base exterior 46 and base interior 40 of the lid can vary, but it is typically similar to the thickness of the distance from the top 50 of the suction cup to the bottom part of the middle rim 52 of the suction cup. In the center of the base interior 40 and the base exterior 46 of lid, is the suction cup placement 48; who's shape is mirrored after the top rim 51 and the middle rim 52 of the suction cup parts. The way in which the suction cup placement 48 gets its shape is during the mold making process; while the plastic material in which the LID is made of is still in liquid form the entire top part of the suction part including the top 50, top rim 51 and the middle rim 52 of suction cup are to be placed into the middle bottom part of the LID. After the top portion of the suction cup has been placed into the bottom of the LID (while the plastic in which the LID is made of, is still in liquid form) the plastic will surround fit into all of the crevices of the the entire top part of the suction cup, and as a result create a tight and secure seal once the plastic hardens. In order to see this take a look at FIG. 4C which shows perspective cross sectional view taken along line 4C-4C of the APPLICATOR attached to the LID of FIG. 4B. Pay close attention to how the suction cup is attached to the bottom of the LID by referring to FIG. 4D (indicated by the broken up line k), which illustrates a separate close up view of the bottom middle part of the LID of FIG. 4C. In FIG. 4D you can that the middle rim 52 of the suction cup has a smaller circumference then that of the top 50 and the top rim 51 of suction cup; and as a result when the plastic material surrounds the middle rim 52 of the suction cup it will keep the suction cup in place when the plastic material (in which the LID is made of) hardens. In FIG. 4D you can also see how the top 50 surface or the suction cup becomes flush with the base interior 40 of the lid.

After the suction cup has been securely attached to the base of the LID, the suction cup is ready to be attached onto a flat hard surface 60. Take a look at FIG. 3A, which illustrates a slight bottom perspective view of the LID with the suction cup bottom about to be attached to a flat hard surface. You can see the end result of the suction cup attachment onto a flat hard surface by referring to FIG. 3B which illustrates a straight perspective view of the LID with the suction cup bottom sealed with the flat hard surface 60. Here you can see the opening of the LID in which is designed to place the APPLICATOR into. You can see right above FIG. 3B, is FIG. 2A which a straight perspective view of the APPLICATOR about to be attached to the TUBE, (The broken lines illustrating a TUBE are for illustrative purposes and are not the invention, but function with the invention) in between both FIG. 3B and FIG. 2B are arrows indicating the direction in which the bottom portion of the APPLICATOR (that is attached to a tube) is to be placed into the open top part of the LID. After the APPLICATOR (that is attached to a tube) has been snapped in place with the LID you can refer to FIG. 4A. Where you can see a straight perspective view of the APPLICATOR (that is attached to a tube) and snapped in placed with the LID with the suction cup bottom that is secured onto a flat hard surface 60. (The broken lines illustrating a tube are for illustrative purposes, to indicate the tube.) This results in the tube being in the up right position, which allows easy and fast access.

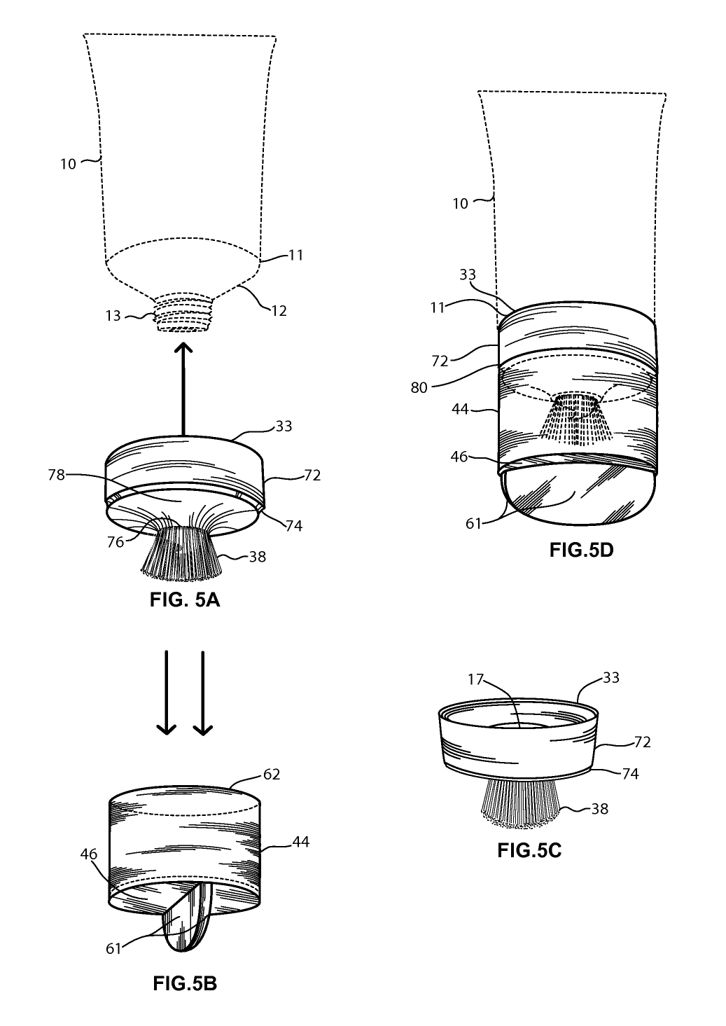

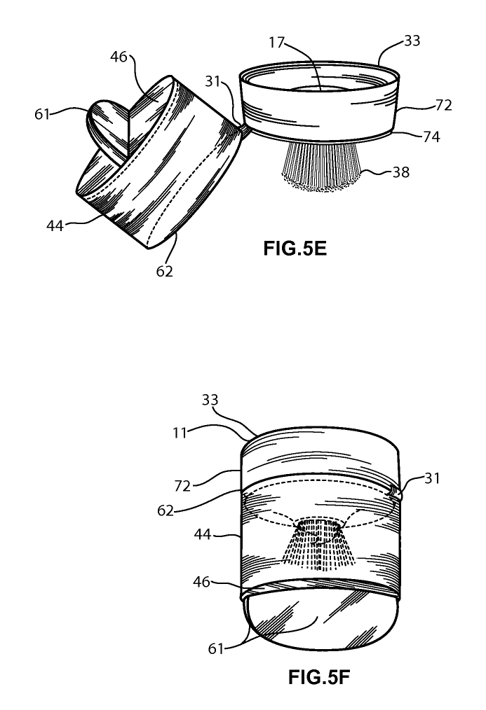

There are many alternatives in which the APPLICATOR of the present invention can be attached and detached to and from the LID of the present invention. In addition there are many variations that both the APPLICATOR and the LID can take shape and size of. Aside from the one I mentioned in the preferred embodiment, another one is illustrated in FIGS. 5A, 5B, 5C and 5D. Take a look at FIG. 5C which shows a slight top perspective view of another version of the APPLICATOR, here you can see a little bit of the female threads 17 in the center of the APPLICATOR. Just as I mentioned before the sized of the female threads 17 can alter to fit onto a wide variety of male threads 13 of various TUBES. In FIG. 5C, you can see the interior 71 of the APPLICATOR, which in hollow in this version of the APPLICATOR. This hollow interior 71 of the APPLICATOR is to fit over and cover the bottom of the TUBE 12, when the male threads 13 of the TUBE are twisted in place with the female threads 17 of the APPLICATOR. As I have mentioned before, the top rim 33 of the APPLICATOR can vary in many sizes to accommodate a proper fit with the base of tubes body 11. You can see how the top rim 33 of the APPLICATOR fits snugly together with the base of tubes body 11, when the TUBE is attached to the APPLICATOR in FIG. 5D. Referring to FIG. 5A which shows a slight bottom perspective view of another version of the APPLICATOR about to be attached to the TUBE, the dashed lines illustrating a TUBE are not part of the invention and FIG. 5B is a side perspective view of another version of the LID, with a pull tab instead of a suction cup bottom. The way that the attachment between the APPLICATOR and the LID is possible, is a result of the exterior indention 74 of the APPLICATOR having a slightly smaller circular sized circumference then that of the interior rim 62 of the LID. That way when the LID is placed over the APPLICATOR, the indention 74 of the APPLICATOR will cover and snap in place with the interior rim 62 of the LID. Since the base of the exterior 72 of the APPLICATOR is lager in circumference then both the the indention 74 of the APPLICATOR and the interior rim 62 of the LID; thus resulting in the base of the exterior 72 of the LID acting like barrier in keeping the LID of the present invention in place with the APPLICATOR apparatus of the present invention. Furthermore, since the exterior circumference of the exterior 72 (of another version of the applicator) is the same size circumference as the exterior circumference as 44, this will result allow for the exterior 72 of the APPLICATOR and for the outer exterior 44 of the LID to become flush with one another. In order to see the result of the LID being attached onto the APPLICATOR look at FIG. 5D which shows a straight perspective view of the TUBE attached to the APPLICATOR attached to the LID with pull tab.

Since the key role of the present inventions LID of the APPLICATOR (aside from keeping the APPLICATOR sealed when it is not in use), is to allow a human to attach and detach the LID to and from the APPLICATOR while using one hand. Another way of allowing a human to attach and detach the LID to and from the APPLICATOR is by placing a pull tab 61 at the base of the LID, in replace of the suction cup. Take a look at FIG. 5B is a side perspective view of another version of the LID, with a pull tab instead of a suction cup bottom; and FIG. 5D is a straight perspective view of the TUBE attached to the APPLICATOR attached to the LID with pull tab. You can see that the pull tab 61 in the side perspective of FIG. 5B is narrow and wide at the straight perspective view as seen in FIG. 5D. The shape, size and material of the pull tab 61 can take many alternatives. In the preferred embodiment I feel that it is best if it is made out of a flexible rubber like material, that is in a shape of a pancake that is cut in half, with thick enough sides to keep its shape without being flimsily. The reason why a flexible rubber material is preferred is because it will allow a more conformable and easer way to pull the tab with the mouth or hand of a human. There are several ways that the pull tab can be attached to the LID, for example the top portion of the pull tab 61 could be glued onto the base of the LID. Another example is if both the LID and the pull tab 61 were made out of the same material, the pull tab 61 will automatically become part of the LID during the mold making process. In the prefer embodiment the top portion of the pull tab 61 is pressed into the base of the LID, during the mold making process. In a similar way that the suction cup is attaches to the base of the LID. That is when the plastic material in which the LID is made out of is still in a liquid state, the top portion of the the pull tab 61 is to be placed into the LIDs base, so when the plastic material hardens in which the LID is made out of, the top portion of the pull tab 61 will remain locked inside of the hardened plastic.

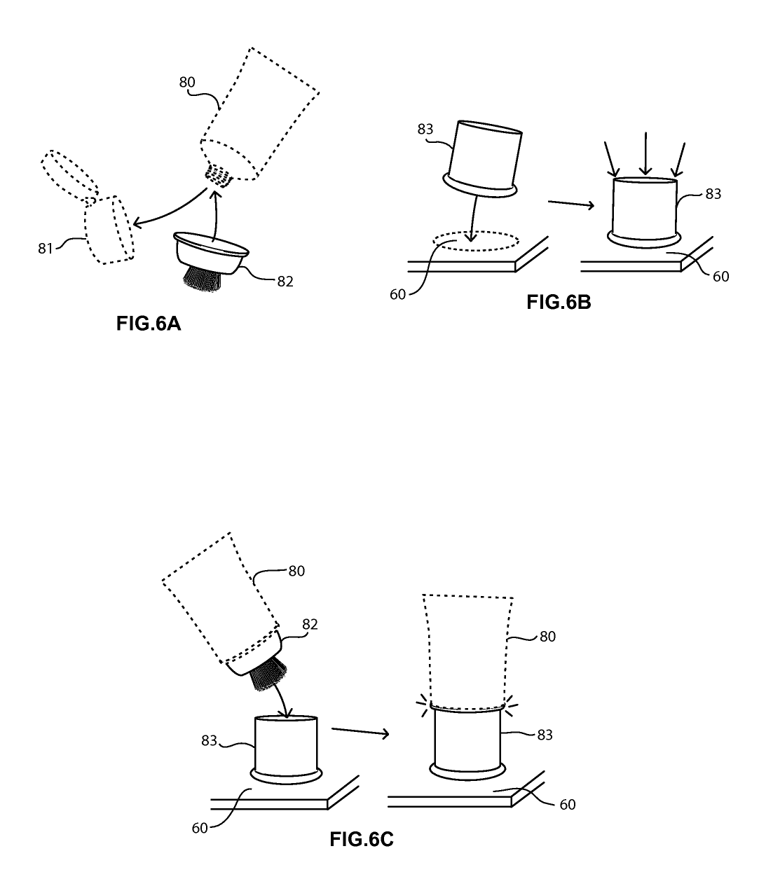

Now that we have an idea of what the APPLICATORs apparatus and the LIDs physical structure and elements, let me explain how to assemble them. Take a look at FIGS. 6A, 6B and 6C, where steps one through three are illustrated in each figure. Beginning with FIG. 6A showing step (1) Remove the prior art cap 81 (illustrated by a broken up line) from the tube 80 (illustrated by a broken up line) and twist the applicator 82 on to the tube 80 (illustrated by a broken up line). Followed by step (2), which is illustrated in FIG. 6B Place the LID 83 with a suction cup bottom on to a flat hard surface 60 and press down firmly, to ensure a tight seal with the suction cup bottom and the flat hard surface 60. The final step (3) is illustrated by FIG. 6C Use the tube 80 (illustrated by a broken up line) as a handle and snap the APPLICATOR 82 into the LID 83 with a suction cup bottom. The present invention is designed to be reused, so when the tube 80 (illustrated by a broken up line) becomes is empty, simply follow steps one through three illustrated by FIGS. 6A, 6B and 6C in order to replace the empty tube 80.

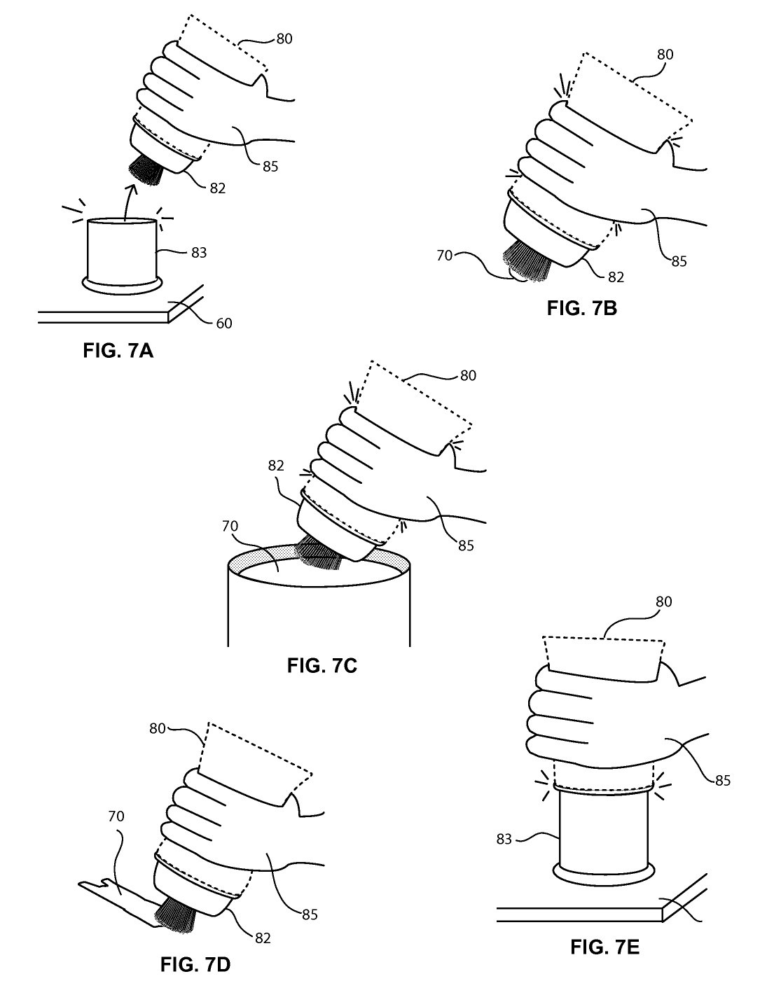

Once you have to assembled the APPLICATOR and LID, the present invention is ready to be used. In order to see how to use the present invention, take your attention to FIGS. 7A, 7B, 7C, 7D, and 7E. Beginning with step (1) represented by FIG. 7A, use the tube 80 (illustrated by a broken up line) as a handle and pull up and away from LID 83 with a suction cup bottom. The APPLICATOR 82 should snap off, leaving the LID 83 with a suction cup bottom attached to the flat hard surface. Followed by step (2), which is shown in FIG. 7B, use the tube 80 (illustrated by a broken up line) as a handle and squeeze the tube 80 (illustrated by a broken up line) until a desired amount of its content such as cream 70 comes from between the brush bristles of the APPLICATOR 82. Another alternative or addition to step (2) is shown in FIG. 7C, instead of squeezing the cream 70 out of the tube 80 (illustrated by a broken up line) use the tube 80 (illustrated by a broken up line) as a handle and dip the brush bristles of the APPLICATOR 82 into the desired content, such as a container of cream 70. Step (3) is shown in FIG. 7D use the tube 80 (illustrated by a broken up line) as a handle and swipe the desired area with the brush bristles of the APPLICATOR 80 covered in the cream 70. Step (3) allows for the user to apply the contents of the tube with out contaminating his or her hand with the cream 70. Then step (4) is, FIG. 7E, use the tube 80 (illustrated by a broken up line) as a handle and snap the APPLICATOR 82 into the LID 83 (with a suction cup bottom). Step (4) is especially easy due to the fact that the LID 83 (with a suction cup bottom) is in the upright position and ready for the APPLICATOR 80 to be snapped in and out of the LID 83 (with a suction cup bottom) with only one hand. Thus allowing the user to have one free hand to hold the child steady. Following the steps one through four, the user was able to preform the entire application process using inly one hand, and without contaminating his or her hand with the desired contents.

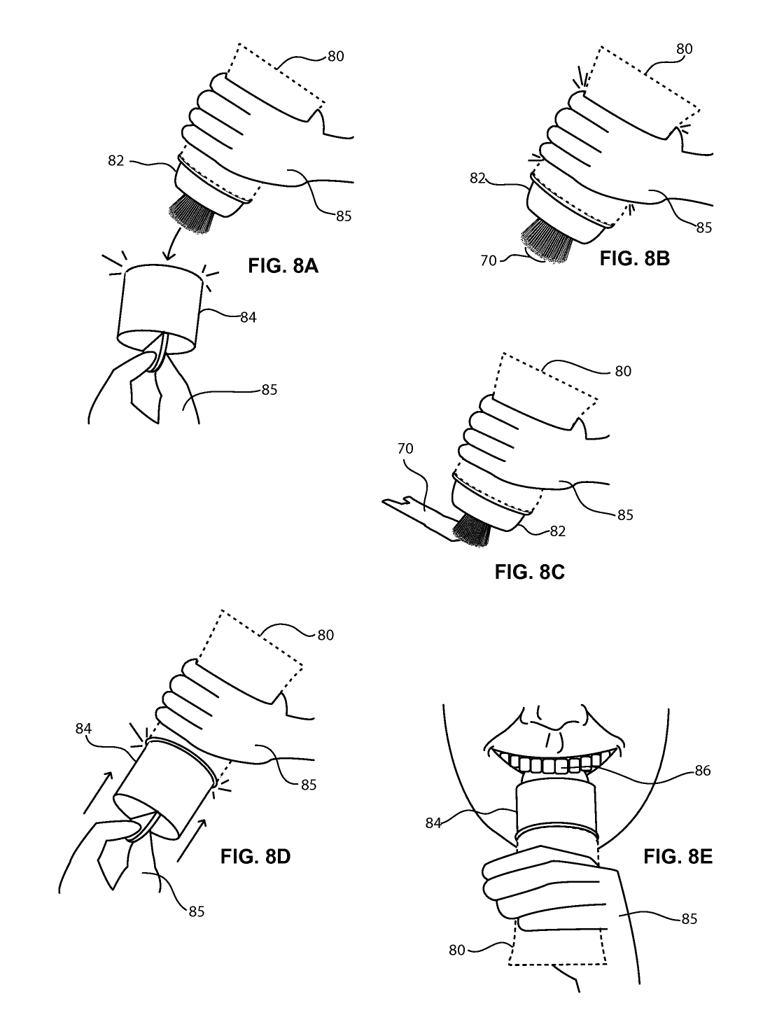

The application process is slightly different with the pull tab bottom then the suction cup bottom of the LID. In order to better understand how to use the APPLICATOR with the LID that has a pull tab refer to FIGS. 8A, 8B, 8C and 8D: The pull tab is particularly useful in situations in which there is no flat surface to place the suction cup bottom to. In addition the pull tab bottom of the LID can be particularly useful when the user is on the go. Because the pull tab allows the user to either pull it off using their hand step (1) is illustrated by FIG. 8A Hold the tube 80 (illustrated by a broken up line) with one hand and pull the tab of the LID 84 (with pull tab bottom) with your hand 85. An alternative to step (1) is illustrated by FIG. 8E which shows an illustration of a user using his or her teeth or mouth 86 in replacement of the other hand 85 to pull the tab of the LID 84 (with pull tab bottom) off of the APPLICATOR 80. The benefit of this alternative is that it allows for the user to have one free hand in the process. Then step (2) is shown in FIG. 8B is the same as FIG. 7B: use the tube 80 (illustrated by a broken up line) as a handle and squeeze the tube 80 (illustrated by a broken up line) until a desired amount of its content such as cream 70 comes from between the brush bristles of the APPLICATOR 82. Followed by step (3) in FIG. 8C which is the sam as FIG. 7D use the tube 80 (illustrated by a broken up line) as a handle and swipe the desired area with the brush bristles of the APPLICATOR 80 covered in the cream 70. Then step (4) represented in FIG. 8D Hold the tube 80 (illustrated by a broken up line) with one hand 85 and snap the APPLICATOR 80 into the LID 84 (with a pull tab bottom) while holding the pull tab with the other hand 85. If the user decided to pull the LID 84 (with a pull tab bottom) with his or her mouth as illustrated in FIG. 8E, and kept the LID 84 (with a pull tab bottom) in his or her mouth 86 then she or he will be able to place the APPLICATOR 80 back into the LID 84 (with a pull tab bottom) while using only one hand 85.

There will be a time when you will may want to clean the present invention and its parts. I recommend this simple three step process: Begin with step (1) wipe the access content such as the cream 70 from the bristles 38, the outer exterior 24, the inner interior 43, the base interior 40 and any other part that is contaminated with the cream 70. Then step (2) Using warm water and soap, wash the remaining content off all part of the invention thoroughly. After that you follow step (3) Either wipe the entire invention with a towel or let air dry. This type of cleaning is recommended at least once a month or whenever desired. In addition, it is recommended (but not mandatory) that the user of the invention cleans the brush bristles at least once a week with either a wet wipe or wash it with soap and water, especially if the bristles are used near or around the diaper area of the child.

While the above description contains many specifies, these should not be construed on the limitations of the scope of the invention, but rather as an exemplification of one (or several) of the preferred embodiments thereof. The scope of the invention should not be determined by the embodiments illustrated, but rather by the appended claims and their legal equivalents. Because many other ramifications and variations are possible within the teachings of the various embodiments. There are many various forms that the present inventions parts can take, each part can change in size, shape and material. They can have different cross sections, such as oval, triangular, rectangular, an so on; they can come in various sizes and be made up of many different materials, such as metals, plastics, woods, and glass. There are various ways in which each of the parts can be connected and attached (detached) from one another. In addition to that some of the preferred embodiments of the present invention could even be eliminated. Although it is impossible to cover every single possible ramification, I think the following are important enough to show how the present invention could alter, while still being able to fix the problems associated with the prior art.

There are infinite types of uses for the present invention. Although I previously stated and described the present invention working in conduction with a tube of diaper rash cream, this does not limit my inventions use in any way. Because the same benefits that are applicable to using the present invention in the application of a diaper rash cream onto a child, can also be useful in applying other types of materials onto other types of surface areas. For example a facial mask, preventing the users fingers getting messy, enabling an even distribution of the content and an over all better feeling sensation of the application process due to a soft bristle brushes. If the user chooses to use the use a tube of paint instead of a mask or cream, this will enable the user to a apply the paint on a desired area without the need to dip the brush into paint, thus enabling a faster and cleaner painting application process.

Although I stated in the petered embodiment that both the APPLICATOR and the LID are to function together, this does not limit them from functioning separately. For example the LID with the suction cup bottom could also function as, a container for any desired item such as a toothbrush or pencil. Referring to FIG. 3B.1 which illustrates a straight perspective view of the LID with the suction cup bottom sealed with the flat hard surface, with an item placed inside. In places like the shower, where objects tend to fall more easily; the suction cup bottom can provide a tight seal with a flat hard surface and any objects such as a razor or toothbrush can be placed into the open part of the LID; and keep them from falling.

Although I stated in the preferred embodiment, that the present invention is to function with a tube; this does not limit my invention to only be used with a tube because a handle 21 can be am alternative to the tube, refer to FIG. 2B.1 which shows a straight perspective view of the APPLICATOR attached to the handle 21. The handle 21 can be made out of thin flexible material such as plastic, aluminum, rubber or silicone and it can be hollow inside and be filled with any desired content. In addition the handle 21 can also be solid inside and be made out of plastic, a lightweight metal, wood, rubber or silicone. There are many shapes and sizes that the handle 21 can take form. In the preferred embodiment I designed a shape that can easily hand held. In FIG. 2B.1, you can see that the shape of the handle 21 has a circular circumference at its base that is similar in size of that of the top rim 33 of the applicator, and gradually gets slightly narrower and wide again towards to top. The shape of the handle 21 allows for a humans hand to easily fit around the middle part of the handle 21. There are several ways in which the handle 21 can be either attached or connected to the tube. One way is the handle 21 can be apart of the APPLICATOR; with the bottom circular circumference of the handle 21 can being permanently attached to the the top rim 33 of the applicator by an adhesive or during the mold making process. Another way is that the handle 21 can be attached and detached to and from the APPLICATOR is by having similar parts as the bottom portion of the TUBE; including male threads that can be twisted in place with the female threads of the APPLICATOR. These are only two examples, many other ways of attaching and detaching the handle 21 to and from the tube are also satisfactory.

The various components of the APPLICATOR apparatus and the LID are typically be made from a variety of well know plastics and therefore can be produced at a relatively low cost. However, it should be understood that various components of any the applicators and lids could be formed of any of variety of metals such as aluminum and would still be relatively light in weight. In addition there are many various alternatives and additives that could be added to either or both parts of the present invention. One of these possible alternatives is a connector flap 31, that is connects to a section of the top rim 33 of the APPLICATOR and to a section of the top rim 41 of the LID. Take a look at FIG. 5E, where in you can see a straight perspective view of the APPLICATOR connected to the LID (with a pull tab bottom), by an attachment flap; with the LID in the open position. And in FIG. 5F is a straight perspective view of the APPLICATOR connected to the LID (with a pull tab bottom), by an attachment flap; with the LID in the closed position. In this version of the invention the connector flap 31, allows for the user to keep the LID connected to the APPLICATOR during throughout the application process. In addition there are no specific colors to any specific parts mainly because the color does not effect the function or the operation of the present invention. In other words all the various parts of the present invention can range in color depending on the preference of its its esthetic visual appearance.

Based on all of the illustrations and description of the illustrations, I have invented novel APPLICATOR and LID apparatus and which thereby fulfills all the objects and advantages which have been sought.

### REFERENCE NUMERALS

10 tubes body: of the tube, which functions with the present invention
11 base of tubes body: of the tube, which functions with the present invention
12 bottom: of the tube, which functions with the present invention
13 male threads: of tube, which function with the present invention
14 bottom rim indention: of the prior art cap
15 bottom rim: of the prior art cap
16 interior top rim: of the prior art cap
17 female threads: of the prior art cap and of the present inventions applicator
18 interior rim: of the prior art caps lid
19 exterior body: of the prior art cap
20 tubes hole: of the tube
21 handle: of applicator
22 inner corner indention: of the applicator
23 bottom rim: of the applicator
24 outer exterior: of the applicator
28 hole tunnel: of the applicator
30 hole base rim: of the applicator
31 attachment flap: of the applicator and the lid
33 top rim: of the applicator
34 inside surface: of the applicator
38 brush bristles: of the applicator
39 sponge: of the applicator
40 base interior: of the lid
41 top rim: of the lid
42 lip interior: of the lid
43 inner interior: of the lid
44 outer exterior: of the lid
46 base exterior: of the lid
48 suction cup placement: of the lid
50 top: of the suction cup
51 top rim: of the suction cup
52 middle rim: of the suction cup
54 outer exterior: of the suction cup
56 bottom: of the suction cup
60 flat hard surface
61 pull tab: of the lid
62 interior rim: of another version of the lid
70 cream: or any other content that is inside the tube
71 interior: of another version of the applicator
72 exterior: of another version of the applicator
74 indention: of another version of the applicator
76 rim: of another version of the applicator
78 base: of another version of the applicator
79 tooth brush: or any other item that can fit inside the open surface of the lid
80 tube
81 prior art: cap with lid
82 APPLICATOR
83 LID: with a suction cup bottom
84 LID: with pull tab bottom
85 Human hand
86 teeth or mouth

b oval broken up line going around the middle of the bottom plan view of the applicator, shown in FIGS. 2G and 2H.

c circular broken up line showing a straight view of the lower middle of the applicator with one side of the brush bristles removed, shown in FIGS. 2E and 2F.

d circular broken up line going around the left side of the cross sectional view of the applicator, shown in FIGS. 2J and 2L.

e circular broken up line going around the right side of the cross sectional view of the applicator, shown in FIGS. 2J and 2E.

f circular broken up line going around the middle lower part of the cross sectional view of the applicator, shown in FIGS. 2J and 2K.

g circular broken up line going around the top left side of the cross sectional view of the lid, shown in FIGS. 3F and 3G.

h circular broken up line going around the top right side of the cross sectional view of the lid, shown in FIGS. 3F and 3H.

i circular broken up line going around the top left side of the cross sectional view of the applicator attached to the lid with the suction cup bottom shown in FIGS. 4C and 4E.

j circular broken up line going around the top right side of the cross sectional view of the applicator attached to the lid with the suction cup bottom, shown in FIGS. 4C and 4F.

k circular broken up line going around the bottom middle part of the cross sectional view of the the lid with the suction cup bottom, shown in FIGS. 4C and 4D.

m circular broken indicating the placement for the suction cup, shown in FIG. 3A.

I claim:

1. An applicator apparatus compromising:
(a) a predetermined shape that can be attached and detached to and from a container, said container compromising a hole in which the containers contents can come out of
(b) a hole in which said contents of said container can come out of
(c) a material attached around said hole as a means for applying said containers contents onto a desired surface area whereby a human does not get his or her hand contaminated with the said containers contents during the application process.

2. A lid compromising:
(a) an opening at one side and an enclosed surface at the opposite side
(b) said enclosed surface of said lid compromising an object such as a suction cup or pull tab that provides the means of attaching and detaching said applicator apparatus of clam 1 to and from said lid whereby a human will be able to use one hand in the process
(c) further more said lid having an alternative function of being a sturdy container for other items.

3. The applicator apparatus of claim 1 and the lid of claim 2 working together to provide a more efficient and hygienic application process in which:
(a) said applicator apparatus of claim 1 is able to be securely attached and easily detached to and from the said opening of the said lid of claim 2 as a means of protecting said material of said applicator apparatus of claim 1 from being contaminated when said applicator apparatus of claim 1 is not in use.
(b) said applicator apparatus of claim 1 further more having the means of being attached and detached to and from the said lid of claim 2 where in a human will be able to use one hand in the process.
